(19) United States
(12) Patent Application Publication
(10) Pub. No.: US 2023/0151236 A1
(43) Pub. Date: May 18, 2023

(54) MAGENTA PIGMENT DISPERSANTS

(71) Applicant: HEWLETT-PACKARD DEVELOPMENT COMPANY, L.P., Spring, TX (US)

(72) Inventors: Marcos A. Barreto Caban, Aguadilla (PR); June Yang, Aguadilla (PR); Elvin Igartua Nieves, Aguadilla (PR)

(21) Appl. No.: 17/916,437

(22) PCT Filed: Jun. 18, 2020
(86) PCT No.: PCT/US2020/038332

§ 371 Date: Sep. 30, 2022

(51) Int. Cl. C09D 11/38; C09B 67/22; C09B 67/46; C09D 11/322; C09D 11/037; C09D 11/033; C09D 11/102

(52) U.S. Cl. CPC C09D 11/38; C09B 67/0036; C09B 67/0085; C09D 11/322; C09D 11/037; C09D 11/033; C09D 11/102

(57) ABSTRACT

A magenta pigment dispersant can include a mixture of quinacridones including a first quinacridone including two nitrogen- and aromatic-containing pendant groups and a second quinacridone with one nitrogen- and aromatic-containing pendant group.

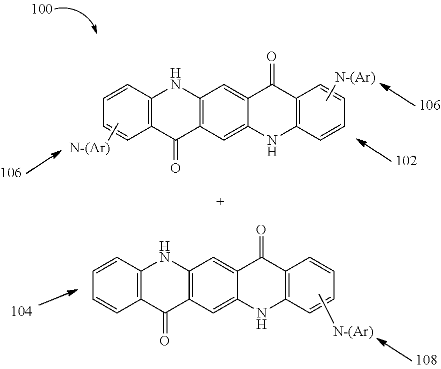

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing a demand for new ink compositions. Pigmented inks in particular have become popular in recent years. However, pigments can sometimes be a challenge as each pigment has different chemistry and thus, behaves differently when printing using inkjet printing technology. For example, some pigments present challenges with respect to stability, decap performance, decel performance, image quality, or the like. Thus, the formulation of pigment dispersions and/or ink compositions that address some of these and/or other issues can be desirable.

### BRIEF DESCRIPTION OF THE DRAWINGS

FIG. 1 graphically depicts an example magenta pigment dispersant in accordance with the present disclosure;

FIG. 2 graphically illustrates an example method of manufacturing a magenta pigment dispersant in accordance with the present disclosure; and

FIG. 3 graphically illustrates an ink composition in accordance with the present disclosure.

### DETAILED DESCRIPTION

The present disclosure is drawn to magenta pigment dispersants, methods of manufacturing magenta pigment dispersants, and ink compositions including magenta pigment dispersions. Pigment based inks can suffer from poor stability and relatively short shelf-life. For example, the shelf-life of pigment based inks can be affected by aggregation of pigment particles within the ink vehicle which can occur due to vibrational and rotational motions that can result in collisions between pigment particles that can lead to pigment particle aggregation. The pigment aggregates can form large particles that can settle out of the ink vehicle. As such, many ink manufacturers have employed various processes, such as high shear mixing, to reduce initial pigment aggregation and finely disperse the pigment during manufacturing. Despite these efforts pigment particles can re-aggregate over time. Magenta pigments that include quinacridone can be highly susceptible to pigment aggregation because these pigments exhibit hydrogen bonding and dipole-dipole attractive forces. Re-aggregation of pigments can be accelerated when an ink is exposed to temperature cycling (e.g. freeze-thaw cycling, for example) during transport, storage, or the like and/or collisions during transport and movement of an ink. Beyond settling, aggregated particles may also block pen fluidic pathways thereby resulting in clogging of an ink channel and preventing printing. Aggregated particles that pass through the ink channel may appear in clumps on a printed medium that can negatively affect an overall appearance of a print. The pigment dispersant and dispersions described herein can help address some of these challenges and can provide magenta pigments dispersions and associated inks with increased shelf-life.

In accordance with the present disclosure, a magenta pigment dispersant includes, in one example, a mixture of quinacridones including a first quinacridone including two nitrogen- and aromatic-containing pendant groups and a second quinacridone with one nitrogen- and aromatic-containing pendant group. In a more detailed example, the first quinacridone can be a di-methylphthalimide quinacridone. In a further example, the magenta pigment dispersant further includes a third quinacridone which may include pigment violet 19. In one example, the magenta pigment dispersant can include from 35 wt % to 50 wt % of the first quinacridone, from 45 wt % to 60 wt % of the second quinacridone, and from 5 wt % to 10 wt % of the third quinacridone, based on a total weight of the magenta pigment dispersant. In another example, a weight ratio of the second quinacridone to the first quinacridone can be from 1:1.5 to 1:0.2. In yet another example, the magenta pigment dispersant can be a powdered dispersant and can have particles with an average particle size ranging from 45 μm to 80 μm. In a further example, the magenta pigment dispersant can be present in a pigment dispersion carried by an aqueous liquid vehicle.

In another example, a method of manufacturing a pigment dispersant, in an example, includes dissolving pigment violet 19 in sulfuric acid to obtain an acidic solution with pigment violet 19 therein and admixing an aromatic amide or imide with the acidic solution to obtain an admixture including the sulfuric acid, the pigment violet 19, and aromatic amide or imide. The method further includes heating the admixture to a temperature ranging from 10° C. to 75° C. for a time period ranging from 15 minutes to 180 minutes and cooling the admixture to a temperature ranging from 0° C. to 30° C. to generate a precipitant. In further detail, the method includes collecting the precipitant in the form of a magenta pigment dispersant. In an example, a molar equivalent of the pigment violet 19 to the aromatic amide or imide in the admixture can be from 1:1 to 1:1.5.

In another example, an ink composition includes a magenta pigment dispersant including a mixture of quinacridones including a first quinacridone including two nitrogen- and aromatic-containing pendant groups and a second quinacridone with one nitrogen- and aromatic-containing pendant group. The in composition in this example further includes a magenta pigment colorant and an aqueous liquid vehicle. In one example, the magenta pigment dispersant can further include a third quinacridone including pigment violet 19. The first quinacridone can include di-methylphthalimide quinacridone and the second quinacridone can include mono-methylphthalimide quinacridone. In another example, the magenta pigment dispersant can be dispersed at from 1.3 wt % to 13.3 wt % on a total weight of magenta pigment colorant in the ink composition. In yet another example, the aqueous liquid vehicle can include from 10 wt % to 50 wt % styrene-acrylic polymer and from 46 wt % to 80 wt % of a co-solvent, based on a total weight of the magenta pigment colorant in the ink composition. In a further example, the co-solvent can be a glycol co-solvent and can include ethylene glycol, diethylene glycol, triethylene glycol, propylene glycol, dipropylene glycol, 2-methyl-1,3-propanediol, tetraethylene glycol, glycerol, 1-(2-hydroxyethyl)-pyrrolidone, tripropylene glycol methyl ether, or a combination thereof.

It is noted that when discussing the magenta pigment dispersant, the method of manufacturing a magenta pigment dispersant, or the ink composition herein, each of these discussions can be considered applicable to one another whether or not they are explicitly discussed in the context of that example. Thus, for example, when discussing a first quinacridone related to a magenta pigment dispersant, such disclosure is also relevant to and directly supported in the context of the method of manufacturing a magenta pigment dispersant, the ink composition, or vice versa.

### Magenta Pigment Dispersants and Dispersions

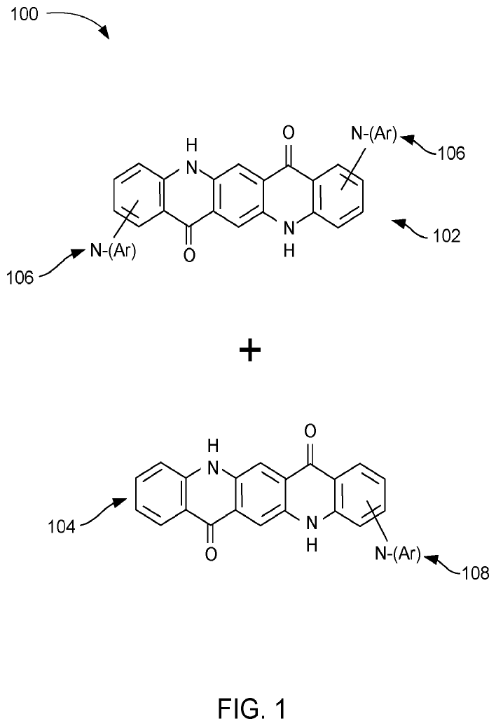

Quinacridone compounds included in the magenta pigment dispersant are illustrated in FIG. 1. The magenta pigment dispersant 100 can include a first quinacridone 102 with two nitrogen- and aromatic-containing pendant groups 106 and a second quinacridone 104 that has a single (one) nitrogen- and aromatic-containing pendant group 108. In one example, the nitrogen- and aromatic-containing pendant groups can be the same on both the first and second quinacridone. In FIG. 1, the nitrogen- and aromatic-containing pendant groups are represented schematically by the N—(Ar). The nitrogen may be on the aromatic ring, or may be on an adjacent portion of the group that may not be aromatic. An example of a compound where the nitrogen is not present on the aromatic ring structure, but is still present on the pendant group as a whole is methylphthalimide.

The nitrogen- and aromatic pendant group(s) can be an imidazole, pyrazole, triazole, tetrazole, pentazole, indole, isoindole, bezimidazole, purine, indazole, pyridine, quinolone, isoquinoline, pyrazine, quinoxaline, pyrimidine, quinazoline, piperidine, imidazole, indolizine, purine, aziridine, diaziridine, azetidine, diazetidine, pyrrole, pyrrolidine, azepane, azocane, azonane, phthalimide, indolene, etc. The pendant group can include, for example, a C1-C3 alkyl linker group to attach the balance of the pendant group to the quinacridone. In one example, the aromatic amide or imide can be a C1-C3 alkyl aromatic amide or imide, and can be a C1-C3 alkyl aromatic imide, such as methylphthalimide, ethylphthalimide, or propylphthalimide. In an example, the C1-C3 alkyl imide can be methylphthalimide. The first quinacridone can be di-methylphthalimide quinacridone. The second can be mono-methylphthalimide quinacridone. The di-methylphthalimide can structurally be formula (I) and the mono-methylphthalimide quinacridone can structurally be formula (II).

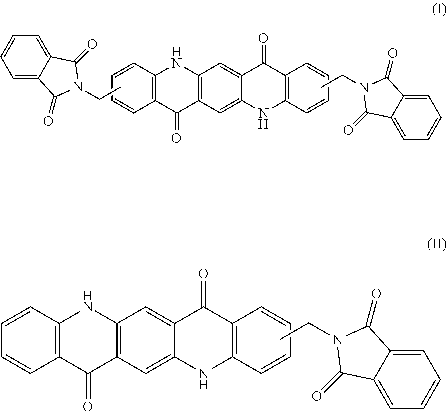

The magenta pigment dispersant presented herein includes first quinacridone and the second quinacridone. The first quinacridone can be present at from 30 wt % to 65 wt %, from 40 w % to 50 wt %, from 35 wt % to 45 wt %, or from about 45 wt % to about 65 wt % and the second quinacridone can be present at from 35 wt % to 70 wt %, from 50 wt % to 60 wt %, or from 55 wt % to 65 wt % based on a total weight of the magenta pigment dispersant. In some examples, a weight ratio of the second quinacridone to the first quinacridone can be from 1:5 to 5:1, from 1:2 to 2:1, from 1:1.5 to 1:0.2, or from 0.9:1 to 1.2:1.

In some examples, the magenta pigment dispersant can further include a third quinacridone, such as pigment violet 19 or a substituted pigment violet 19, e.g., sulfonated pigment violet 19. The first quinacridone can be present at from 35 wt % to 50 wt %. The second quinacridone can be present at from 45 wt % to 60 wt %. The third quinacridone, e.g., PV19, can be present at from 5 wt % to 10 wt % based on a total weight of the magenta pigment dispersant. In yet other examples, the first quinacridone can be present at from 40 wt % to 50 wt %, from 35 wt % to 45 wt % or from 40 wt % to 45 wt %. The second quinacridone can be present at from 45 wt % to 55 wt %, from 50 wt % to 60 wt %, or from 47 wt % to 57 wt %. The pigment violet 19 can be present at from 7 wt % to 9 wt % or 6 wt % to 8 wt %.

In some examples, the magenta pigment dispersant can be a powdered dispersant. Particles of the powdered dispersant can have an average size ranging from 45 μm to 80 μm. The particles can have an average particle size ranging from 50 μm to 75 μm, from 60 μm to 80 μm, or from 48 μm to 68 μm. The terms “size” or “particle size,” as used herein, refer to the diameter of a substantially spherical particle, or the effective diameter of a non-spherical particle, e.g., the diameter of a sphere with the same mass and density as the non-spherical particle as determined by weight. Particle size information can be determined and/or verified using a scanning electron microscope (SEM), or can be measured using a particle analyzer such as a MASTERSIZER™ 3000 available from Malvern Panalytical, for example. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. Particle size can be reported as a volume equivalent sphere diameter. An average particle size can refer to a mathematical average of the particle sizes.

In yet other examples, the magenta pigment dispersant can be dispersed in and carried by an aqueous liquid vehicle, and can be co-dispersed with a pigment, thus forming either a pigment dispersion concentrate or an ink composition. In some examples, the aqueous liquid vehicle can be water. In yet other examples, the aqueous liquid vehicle can include water and other components as identified below in the context of the liquid vehicle. In an example, the magenta pigment colorant can include quinacridone based pigments as well. The magenta pigment dispersant can be present based on an amount of magenta pigment colorant in the pigment dispersion. For example, the magenta pigment dispersant can be present at from 1.3 wt % to 13.3 wt % based on weight of magenta pigment colorant in the pigment dispersion. In yet other examples, the magenta pigment dispersant can be present at from 2 wt % to 12 wt %, from 5 wt % to 10 wt %, or from 1.3 wt % to 9 wt % based on a total weight of the magenta pigment colorant in the pigment dispersion. In some examples the pigment dispersion can be a colorant concentrate.

When dispersed in an aqueous liquid vehicle, a structure of the magenta pigment dispersant can hinder pigment particle agglomeration. As used herein, “particle agglomeration” refers to an increase in a cumulative particle size as particles adhere to each other. When referring to particle agglomeration, the cumulative particle size refers to the diameter of a spherical grouping of particles, or the longest dimension of a non-spherical grouping of particles.

The aromatic amide or imide groups on the quinacridone can act to sterically hinder intermolecular interactions between magenta pigment colorant particles that may be dispersed therewith, thereby minimizing or preventing particle agglomeration of the magenta pigment colorant particles. The aromatic amide or imide groups can also act to prevent physical interactions between magenta pigment colorant particles that may be dispersed therewith. The aromatic amide or imide groups can also act to repel physical interactions between magenta pigment colorant particles that may be dispersed therewith.

### Methods of Manufacturing Magenta Pigment Dispersants

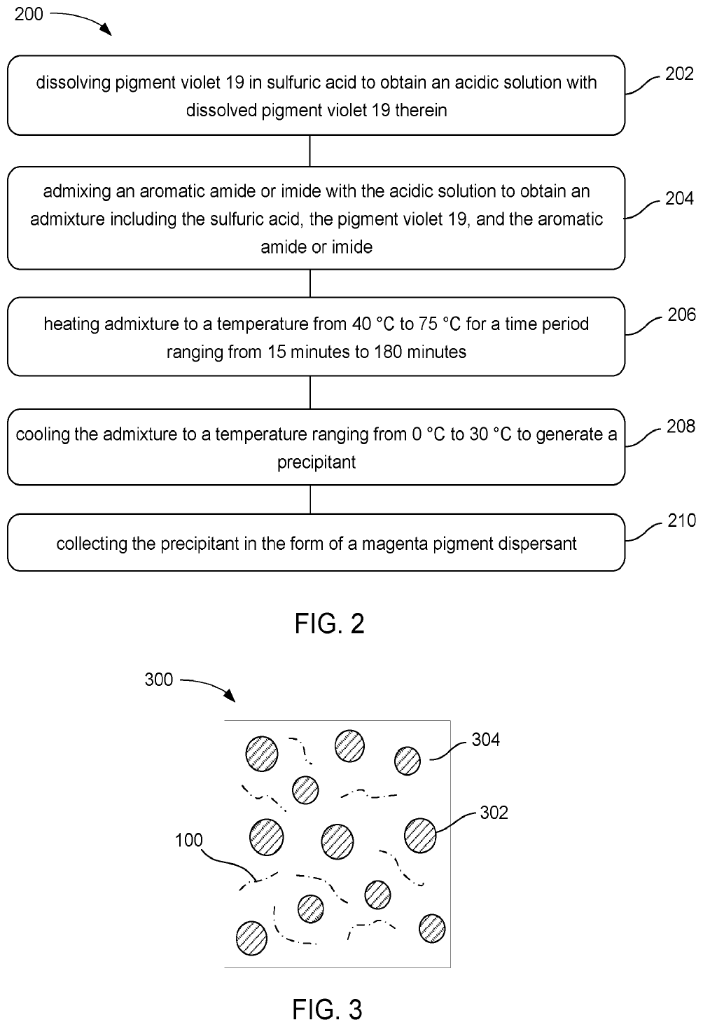

A flow diagram of an example method of manufacturing a magenta pigment dispersant is presented in FIG. 2. The method can include dissolving 202 pigment violet 19 in sulfuric acid to obtain an acidic solution with dissolved pigment violet 19 therein, and admixing 204 an aromatic amide or imide with the acidic solution to obtain an admixture including the sulfuric acid, the dissolved pigment violet 19, and dissolved aromatic amide or imide. The method can also include heating 206 the admixture to a temperature from 10° C. to 75° C. for a time period from 15 minutes to 180 minutes, cooling 208 the admixture to a temperature ranging from 0° C. to 30° C. to generate a precipitant, and collecting the precipitant in the form of a magenta pigment dispersant.

In further detail, in an example, the dissolving can occur in concentrated sulfuric acid. The concentrated sulfuric acid can have a sulfur trioxide concentration ranging from 90 wt % to 100 wt %, from 95 wt % to 100 wt %, or from 95 wt % to 99 wt %. The aromatic amide or imide can be added to the acidic solution in an amount equal to or an amount in excess of an amount of the pigment violet 19 dissolved in the acidic solution. In one example, a molar equivalent of the pigment violet 19 to the aromatic amide or imide in the admixture can range from 1:1 to 1:1.5, from 1:1 to 1:1.25, or from 1:1.25 to 1:5. In an example, the aromatic amide or imide can include N-(hydroxymethyl)phthalimide, or any of the aromatic amide or imides identified above.

Temperatures and reaction times may be controlled. Controlling a temperature during the method can allow for control of an amount of the first quinacridone and the second quinacridone formed. Electrophilic substitution can occur between the aromatic amide or imide and the pigment violet 19. This electrophilic substitution can occur almost instantaneously upon addition of the aromatic amide or imide, when added at a temperature at or below 15° C. Accordingly, the aromatic amide or imide can be added to a cooled acidic solution. For example, the acidic solution may have a temperature of 1° C. to 15° C., 5° C. to 15° C., 10° C. to 15° C., 3° C. to 6° C., or 6° C. to 12° C. when the aromatic amide or imide is added thereto.

Upon admixing the aromatic amide or imide into the acidic solution, the admixture can be heated. As the admixture is heated, a second electrophilic substitution reaction can occur between a second quinacridone and unbound aromatic amide or imides in the solution thereby forming a first quinacridone. An amount of the first quinacridone can be dependent on the heating rate and final temperature. In one example, the heating can occur at a temperature ranging from 10° C. to 75° C., from 20° C. to 60° C., from 15° C. to 60° C., from 40° C. to 75° C., or from 50° C. to 75° C. In some examples, the heating can occur at a rate of 1° C. per minute to 5° C. per minute. The heating can occur at a total time of 60 minutes, 120 minutes, 180 minutes, or 240 minutes. When a desired temperature is reached, the temperature can be isothermally held for a time period ranging from 10 minutes to 20 minutes, 10 minutes to 15 minutes, or from 15 minutes to 20 minutes. The heated admixture can then be cooled to a temperature ranging from 0° C. to 30° C., from 5° C. to 25° C., from 10° C. to 30° C., or from 5° C. to 15° C. In some examples, the cooling can occur in an isolation tank with water. The cooling may occur by gravity.

Following cooling, a precipitant can be collected. In some examples the precipitant can be treated further. The precipitant may then be filtered, ground, dried, or any combination thereof. Filtering and/or grinding can be used to achieve a powdered precipitant having an average particle size ranging from 45 μm to 80 μm. Filtering can occur by mechanical filtration, reverse osmosis, granular media filtration, or the like. In one example, the filtering can occur by mechanical filtration. Filtering can also separate a precipitant from the cooled solution and/or can separate larger sized particles from smaller sized particles. Grinding can occur by mechanical grinding, crushing, bead milling, or the like. Drying may occur by air drying or by drying with a heating element, such as in an oven to yield the precipitant.

In some examples, the magenta pigment dispersant can then be admixed with an aqueous liquid vehicle to form a liquid magenta pigment dispersant. In yet other examples, the precipitated magenta pigment dispersant can be admixed with an aqueous liquid vehicle and a magenta pigment colorant to form a pigment dispersion. In yet other examples, the magenta pigment dispersant in powder or liquid form can be admixed with a colorant and an aqueous liquid vehicle to form an ink composition.

### Ink Compositions

An ink composition 300 is shown schematically in FIG. 3, and can include a magenta pigment dispersant 100, a magenta pigment colorant 302, and an aqueous liquid vehicle 304. The magenta pigment dispersant can include a first quinacridone and a second quinacridone, the first quinacridone can include two nitrogen- and aromatic-containing side groups. The second quinacridone has a single (one) nitrogen- and aromatic-containing side groups. In one specific example, the magenta pigment dispersant can further include a third quinacridone, such as pigment violet 19. The first quinacridone can include a di-methylphthalimide quinacride. The second quinacridone can include mono-methylphthalimide quinacridone. The magenta pigment dispersant can include from 35 wt % to 50 wt % di-methylphthalimide quinacridone, from 45 wt % to 60 wt % mono-methylphthalimide quinacridone, and from 5 wt % to 10 wt % pigment violet 19 based on a total weight of the magenta pigment dispersant.

The ink composition can be an aqueous ink composition. Water can be the primary solvent and can make up a significant portion of the ink composition. In one example, the water can be the only solvent in the ink composition. In yet other examples, water can be present at from 50 wt % to 93 wt %, from 50 wt % to 70 wt %, from 90 wt % to 100 wt %, from 75 wt % to 95 wt %, or from 55 wt % to 65 wt % in the ink composition. In some examples, the water can be deionized, purified, or a combination of purified and deionized.

In some examples, the aqueous liquid vehicle can include a co-solvent. The co-solvent can be present in the ink composition at from 2 wt % to 50 wt %, from 2 wt % to 15 wt %, from 10 wt % to 25 wt %, from 25 wt %, to 50 wt %, or from 5 wt % to 12 wt %. The co-solvent can include, in an example, a glycol co-solvent. Example glycol co-solvents can include ethylene glycol, diethylene glycol, triethylene glycol, propylene glycol, dipropylene glycol, 2-methyl-1,3-propanediol, tetraethylene glycol, glycerol, 1-(2-hydroxyethyl)-pyrrolidine, tripropylene glycol methyl ether, or a combination thereof. In another example the glycol co-solvent can include dipropylene glycol, triethylene glycol, or a combination thereof.

In other examples, the aqueous liquid vehicle can include a styrene-acrylic polymer. The styrene-acrylic polymer can act as a secondary dispersant for the ink composition. The styrene acrylic polymer can be formed of polymers including acrylic acid, methyl methacrylate, butyl acrylate, ethyl acrylate, butyl methacrylate, 2-ethylhexyl acrylate, styrene, methyl styrene, poly styrene, and the like. Commercially available examples of styrene-acrylic polymers can include Joncryl® 683, Joncryl® 671, Joncryl® 586, and Joncryl® 696 all available from BASF Corp. (Germany). The styrene acrylic resin may associate with a surface of the magenta pigment colorant, e.g., adsorption, hydrogen bonding, or other similar attractions with the surface of the magenta pigment colorant, and may further prevent particle agglomeration.

The magenta pigment colorant can include any magenta pigment. In one example, the magenta pigment colorant can be a quinacridone. Magenta quinacridones can include pigment violet (PV) 15, PV 19 (as the pigment colorant either in addition to or independent of the pigment dispersant), PV 42, PV 122, PV 202, and combinations thereof.

In some examples, a weight ratio of components in the ink composition can be based on an amount of the magenta pigment colorant in the ink composition. In one example, the magenta pigment dispersant can be present at from 1.3 wt % to 13.3 wt %, from 2 wt % to 12 wt %, from 5 wt % to 10 wt %, or from 1.3 wt % to 6 wt % based on a total weight of magenta pigment colorant. In yet another example, the aqueous liquid vehicle can include from 10 wt % to 50 wt %, from 25 wt % to 50 wt %, or from 10 wt % to 30 wt % styrene-acrylic polymer and from 46 wt % to 80 wt %, from 50 wt % to 75 wt %, or from 46 wt % to 60 wt % co-solvent based on a total weight of the magenta pigment colorant in the ink composition.

The ink compositions (and dispersed pigment concentrates used to formulate ink compositions) can include an aqueous liquid vehicle. As used herein, the term “aqueous liquid vehicle” may refer to the liquid of a pigment dispersion or an ink composition. The aqueous liquid vehicle may include water alone or in combination with a variety of additional components. Examples of components that may be included, in addition to water, may include co-solvent, surfactant, buffer, antimicrobial agent, anti-kogation agent, chelating agent, buffer, etc. In an example, the aqueous liquid vehicle can include water and a co-solvent. In another example, the aqueous liquid vehicle can include water, co-solvent, and a surfactant. In yet another example, the aqueous liquid vehicle can include water, co-solvent, surfactant, and buffer or buffer and a chelating agent.

The aqueous liquid vehicle can include water that may be deionized, for example. In one example, water can be present at from 50 wt % to 93 wt %, from 50 wt % to 70 wt %, from 90 wt % to 100 wt %, from 75 wt % to 95 wt %, or from 55 wt % to 65 wt %.

The water in the aqueous liquid vehicle may include a co-solvent(s). Some examples of co-solvent(s) that may be added to the aqueous liquid vehicle can include ethanol, methanol, propanol, acetone, tetrahydrofuran, hexane, 1-butanol, 2-butanol, tert-butanol, isopropanol, propylene glycol, methyl ethyl ketone, dimethylformamide, 1,4-dioxone, acetonitrile, 1,2-butanediol, 1-methyl-2,3-propanediol, 2-pyrrolidone, glycerol, 2-phyenoxyethanol, 2-phenylethanol, 3-phenylpropanol, or a combination thereof. Whether a single co-solvent is included or a combination of co-solvents are included, a total amount of co-solvent(s) in the dispersant or the ink composition can range from 2 wt % to 50 wt %, from 2 wt % to 15 wt %, from 10 wt % to 25 wt %, from 25 wt %, to 50 wt %, or from 5 wt % to 12 wt %, based on a total weight of the pigment dispersion or the ink composition.

The aqueous liquid vehicle may also include surfactant. The surfactant can include a non-ionic surfactant, a cationic surfactant, and/or an anionic surfactant. Example non-ionic surfactants that can be used include self-emulsifiable, nonionic wetting agents based on acetylenic diol chemistry (e.g., SURFYNOL® SEF from Air Products and Chemicals, Inc., USA), a fluorosurfactant (e.g., CAPSTONE® fluorosurfactants from DuPont, USA), or a combination thereof. In other examples, the surfactant can be an ethoxylated low-foam wetting agent (e.g., SURFYNOL® 440, SURFYNOL® 465, or SURFYNOL® CT-111 from Air Products and Chemical Inc., USA) or an ethoxylated wetting agent and molecular defoamer (e.g., SURFYNOL® 420 from Air Products and Chemical Inc., USA). Still other surfactants can include wetting agents and molecular defoamers (e.g., SURFYNOL® 104E from Air Products and Chemical Inc., USA), alkylphenylethoxylates, solvent-free surfactant blends (e.g., SURFYNOL® CT-211 from Air Products and Chemicals, Inc., USA), water-soluble surfactant (e.g., TERGITOL® TMN-6, TERGITOL® 15S7, and TERGITOL® 15S9 from The Dow Chemical Company, USA), or a combination thereof. In other examples, the surfactant can include a non-ionic organic surfactant (e.g., TEGO® Wet 510 from Evonik Industries AG, Germany), a non-ionic secondary alcohol ethoxylate (e.g., TERGITOL® 15-S-5, TERGITOL® 15-S-7, TERGITOL® 15-S-9, and TERGITOLe 15-S-30 all from Dow Chemical Company, USA), or a combination thereof. Example anionic surfactants can include alkyldiphenyloxide disulfonate (e.g., DOWFAX® 8390 and DOWFAX® 2A1 from The Dow Chemical Company, USA), and oleth-3 phosphate surfactant (e.g., CRODAFOS™ N3 Acid from Croda, UK). Example cationic surfactant that can be used can include dodecyltrimethylammonium chloride, hexadecyldimethylammonium chloride, or a combination thereof. In some examples, the surfactant (which may be a blend of multiple surfactants) may be present in the ink composition at an amount ranging from 0.01 wt % to 2 wt %, from 0.05 wt % to 1.5 wt %, or from 0.01 wt % to 1 wt %.

In some examples, the aqueous liquid vehicle may further include a chelating agent, an antimicrobial agent, a buffer, or a combination thereof. While an amount of these may vary, if present, these can be present in the pigment dispersion or the ink composition at a total amount ranging from 0.001 wt % to 20 wt %, from 0.05 wt % to 10 wt %, or from 0.1 wt % to 5 wt %.

The aqueous liquid vehicle may include a chelating agent. Chelating agent(s) can be used to minimize or to eliminate the deleterious effects of heavy metal impurities. Examples of suitable chelating agents can include disodium ethylene-diaminetetraacetic acid (EDTA-Na), ethylene diamine tetra acetic acid (EDTA), and methyl-glycinediacetic acid (e.g., TRILON® M from BASF Corp., Germany). If included, whether a single chelating agent is used or a combination of chelating agents is used, the total amount of chelating agent(s) in the pigment dispersion or the ink composition may range from 0.01 wt % to 2 wt % or from 0.01 wt % to 0.5 wt %.

The aqueous liquid vehicle may also include antimicrobial agents. Antimicrobial agents can include biocides and fungicides. Example antimicrobial agents can include the NUOSEPT (Ashland Inc., USA), VANCIDE® (R.T. Vanderbilt Co., USA), ACTICIDE® B20 and ACTICIDE® M20 (Thor Chemicals, U.K.), PROXEL® GXL (Arch Chemicals, Inc., USA), BARDAC® 2250, 2280, BARQUAT® 50-65B, and CARBOQUAT® 250-T, (Lonza Ltd. Corp., Switzerland), KORDEK® MLX (The Dow Chemical Co., USA), and combinations thereof. In an example, if included, a total amount of antimicrobial agents in the pigment dispersion or the ink composition agent can range from 0.01 wt % to 1 wt %.

In some examples, an aqueous liquid vehicle may further include a buffer. The buffer can withstand small changes (e.g., less than 1) in pH when small quantities of a water-soluble acid or a water-soluble base are added to a composition containing the buffer. The buffer can have pH ranges from 5 to 9.5, from 7 to 9, or from 7.5 to 8.5. In some examples, the buffer can include a poly-hydroxy functional amine. In other examples, the buffer can include potassium hydroxide, 2-[4-(2-hydroxyethyl) piperazin-1-yl] ethane sulfonic acid, 2-amino-2-(hydroxymethyl)-1,3-propanediol (TRIZMA® sold by Sigma-Aldrich, USA), 3-morpholinopropanesulfonic acid, triethanolamine, 2-[bis-(2-hydroxyethyl)-amino]-2-hydroxymethyl propane-1,3-diol (bis tris methane), N-methyl-D-glucamine, N,N,N′N′-tetrakis-(2-hydroxyethyl)-ethylenediamine and N,N,N′N′-tetrakis-(2-hydroxypropyl)-ethylenediamine, beta-alanine, betaine, or mixtures thereof. In yet other examples, the buffer can include 2-amino-2-(hydroxymethyl)-1,3-propanediol (TRIZMA® sold by Sigma-Aldrich, USA), beta-alanine, betaine, or mixtures thereof.

### Definitions

It is noted that, as used in this specification and the appended claims, the singular forms “a,” “an,” and “the” include plural referents unless the content clearly dictates otherwise.

As used herein, a plurality of items, structural elements, compositional elements, and/or materials may be presented in a common list for convenience. However, these lists should be construed as though an individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. However, it is to be understood that the following is only illustrative of the application of the principles of the present disclosure. Numerous modifications and alternative ink compositions, ink sets, methods, etc., may be devised without departing from the scope of the present disclosure. The appended claims are intended to cover such modifications and arrangements.

### Example 1—Preparation of Magenta Pigment Dispersants and Pigment Dispersions

A pigment dispersant was prepared by reacting 55 g pigment violet 19 in 400 mL of concentrated sulfuric acid. The solution was cooled to between 3° C. to 6° C. and 45 g of N-hydroxymethylphthalimide (the aromatic amide or imide) was added thereto. The mixture was heated at a rate of 1° C. per minute to a temperature of 45° C. The mixture was transferred to an isolation tank with 6° C. deionized iced water by gravity over 24 minutes. The precipitant was washed and filtered until a final pH was at 6.5. The material was then dried and pulverized into a fine powder. The resulting powder included 53 wt % mono-methylphthalimide quinacridone, 40 wt % di-methylphthalimide quinacridone, and 7 wt % PV 19. A ratio of the mono-methylphthalimide quinacridone to the di-methylphthalimide quinacridone was around 0.9:1 to 1.2:1.

Several pigment dispersions were prepared according to the following protocols. The magenta pigment dispersant was added to a co-solvent and mixed as a dispersion in a hi-shear mixture up to 50° C. to de-agglomerate the particles. The admixture was then dosed into an aqueous solution including water and a styrene acrylic co-polymer. The solution was stirred for 15 minutes and then dosed with a magenta pigment. The solution was then further processed using a hi-shear mixer to de-agglomerate pigment particles therein. The mixture was subsequently processed by agitated media milling, a double planetary mixing device, or a combination thereof. The resultant mixture was processed until a particle size of from 0.12 μm to 0.15 μm was achieved, and then filtered to remove large particles above about 0.5 μm in size

The various pigment dispersions prepared according to this protocol are indicated as A-D, and control formulations are labeled as C1-C3, as follows:

TABLE 1
Pigment Dispersion Formulations

| Ingredient | Ingredient Type | C1 | C2 | C3 | A | B | C | D |
|---|---|---|---|---|---|---|---|---|
| Joncryl ® 683 | Styrene-Acrylic | 3.74 | — | — | 3.89 | — | — | — |
| K⁺ salt 80% | Polymer | | | | | | | |
| neutralization | | | | | | | | |
| Joncryl ® 683 | Styrene-Acrylic | — | 6.06 | — | — | 6.06 | 6.06 | 6.06 |
| K⁺ salt 100% | Polymer | | | | | | | |
| neutralization | | | | | | | | |
| Joncryl ® 671 | Styrene-Acrylic | — | — | 3.6 | — | — | — | — |
| K⁺ salt 107% | Polymer | | | | | | | |
| neutralization | | | | | | | | |
| Dipropylene glycol | Co-solvent | 8.93 | — | — | 9.29 | — | — | — |
| Triethylene glycol | Co-solvent | — | 10 | — | — | 10 | 10 | 10 |
| LEG-1 | Co-solvent | — | — | 0.5 | — | — | — | — |
| 2-methyl-1,3- | Co-solvent | — | — | 8 | — | — | — | — |
| propanediol | | | | | | | | |
| Magenta Pigment | Dispersant | — | — | — | 0.8 | 0.80 | 0.40 | 1.20 |
| Dispersant | | | | | | | | |
| Fastogen ® MJ01 | Magenta Pigment | 20 | 20 | 20 | 20 | 20 | 20 | 20 |
| | Colorant | | | | | | | |
| Water | Solvent | 67.33 | 63.94 | 67.9 | 66.02 | 62.6 | 63.54 | 62.74 |

Joncryl ® polymers are commercially available from BASF (Germany).
Cinquasia ® Magenta D 4550 J is commercially available from BASF (Germany).
Fastogen ® MJ01 is commercially available from Sun Chemical Corporation (USA).

### Example 2—Pigment Dispersant Stability Testing

Control Formulation C1 and Pigment Dispersant Formulation A were evaluated for particle agglomeration. In order to assess particle agglomeration, pigment size was monitored over time. The pigment dispersions were subjected to temperature cycle (T-cycle) testing and accelerated storage testing (ASL) at 60° C. T-cycle testing was performed by ramping the temperature between −40° C. and 70° C. followed by a 4 hour temperature hold for 10 cycles. The results of the stability testing are presented in Table 2.

TABLE 2
Pigment Agglomeration - Stability Testing

| Pigment | Pigment Dispersant | Ambient Particle | Aged Particle |
|---|---|---|---|
| Dispersion ID | Included | Size (nm) | Size (nm) |
| C1 | No | 130 | 234 |
| A | Yes | 131 | 135 |

As can be seen in Table 2, adding the magenta pigment dispersant prepared in Example 1 to the pigment dispersion minimized particle agglomeration over time thereby indicating an increased shelf life.

### Example 3—Ink Composition Preparation and Reliability

Control Pigment Dispersions C2 and C3, as well as Pigment Dispersion B, C, and D were used to formulate several ink compositions. Two control formulations were tested. C2 was tested as a comparative formulation which excluded the magenta pigment dispersant. C3 was tested because it is known to be a highly stable formulation. If negative results appeared for C3, then it would indicate errors in the application of the testing. In this example, the respective pigment dispersions were combined with an ink-vehicle containing 0.3 wt % surfactant, 11 wt % humectant, 0.22 wt % biocide, 0.5 wt % anti-kogation additive, and a 3.5 wt % polyurethane binder. The formulations were then filled into a thermal inkjet pen/cartridge (Hewlett Packard A8124 pens) and were fired on a pen/cartridge life test apparatus for the life of the pen/cartridge. For this test, no media was used. Rather, the pen/cartridge life test apparatus exercised the pen/cartridge, and the ink drops were ejected into a spittoon. At certain intervals and at the end of the pen/cartridge life (over 800 million drops per nozzle), the pen/cartridge drop velocity and drop weight were monitored and the change at the end of the pen/cartridge life (noted as Drop Weight Loss % and Drop Velocity Loss % in Table 3 below) was calculated. Drop weight was determined by a N-drop tester, in which numbers of fired droplets for each nozzle were weighed on an analytical balance and the average weight of each droplet per nozzle was calculated by total mass over number of droplets, Drop velocity was determined by an Eye drop tester in which drops were fired from a print head at a fixed distance from a laser; the laser was split into two sensors that allowed drop velocity estimation in m/s for each nozzle. The results of the ink reliability testing are indicated in Table 3.

TABLE 3
Ink Stability Testing Data

| Formula- | Amount | Drop | Drop | Drop | Drop | % |
|---|---|---|---|---|---|---|
| tion | Pigment | Weight | velocity | Weight | Velocity | Nozzle |
| ID | Dispersant | (ng) | (m/s) | % Loss | % Loss | Health |
| C2 | 0 | 6 | 6.8 | 6 | 7 | 100 |
| C3 | 0 | 5.9 | 6.8 | 4.3 | 2.1 | 100 |
| B | 0.8 | 6.1 | 6.8 | 5.8 | 6.6 | 100 |
| C | 0.4 | 6.2 | 6.6 | 9.7 | 7 | 100 |
| D | 1.2 | 6.1 | 6.9 | 9 | 8.5 | 100 |

All of the ink compositions exhibited acceptable drop weight, drop velocity, and nozzle health parameters. The addition of the pigment dispersant to the ink composition did not negatively affect printability of the ink compositions, but had the added benefit of good stability, including long term storage stability.

What is claimed is:

1. A magenta pigment dispersant comprising a mixture of quinacridones including a first quinacridone including two nitrogen- and aromatic-containing pendant groups and a second quinacridone with one nitrogen- and aromatic-containing pendant group.

2. The magenta pigment dispersant of claim 1, wherein the nitrogen- and aromatic-containing pendant groups include a C1-C3 alkyl linker group.

3. The magenta pigment dispersant of claim 1, wherein the first quinacridone is a di-methylphthalimide quinacridone.

4. The magenta pigment dispersant of claim 1, wherein the magenta pigment dispersant further includes a third quinacridone, wherein the third quinacridone includes pigment violet 19.

5. The magenta pigment dispersant of claim 4, wherein the magenta pigment dispersant includes from 35 wt % to 50 wt % of the first quinacridone, from 45 wt % to 60 wt % of the second quinacridone, and from 5 wt % to 10 wt % of the third quinacridone, based on a total dry weight of the magenta pigment dispersant.

6. The magenta pigment dispersant of claim 1, wherein a weight ratio of the second quinacridone to the first quinacridone is from 1:5 to 5:1.

7. The magenta pigment dispersant of claim 1, wherein the magenta pigment dispersant is a powdered dispersant having particles with an average size from 45 μm to 80 μm.

8. The magenta pigment dispersant of claim 1, wherein the magenta pigment dispersant is associated with a magenta pigment colorant carried by an aqueous liquid vehicle.

9. A method of manufacturing a magenta pigment dispersant, comprising:
dissolving pigment violet 19 in sulfuric acid to obtain an acidic solution with pigment violet 19 therein;
admixing an aromatic amide or imide with the acidic solution to obtain an admixture including the sulfuric acid, the pigment violet 19, and the aromatic amide or imide;
heating admixture to a temperature from 40° C. to 75° C. for a time period ranging from 15 minutes to 180 minutes;
cooling the admixture to a temperature ranging from 0° C. to 30° C. to generate a precipitant; and
collecting the precipitant in the form of a magenta pigment dispersant.

10. The method of claim 9, wherein a molar equivalent of the pigment violet 19 to the aromatic amide or imide in the admixture is from 1:1 to 1:1.5.

11. An ink composition, comprising,
a magenta pigment dispersant comprising a mixture of quinacridones including a first quinacridone including two nitrogen- and aromatic-containing pendant groups and a second quinacridone with one nitrogen- and aromatic-containing pendant group;
a magenta pigment colorant; and
an aqueous liquid vehicle.

12. The ink composition of claim 11, wherein the magenta pigment dispersant further includes a third quinacridone including pigment violet 19, and wherein the first quinacridone comprises di-methylphthalimide quinacridone and the second quinacridone comprises mono-methylphthalimide quinacridone.

13. The ink composition of claim 11, wherein the magenta pigment dispersant is dispersed in the ink composition at from 1.3 wt % to 13.3 wt % based on a total weight of magenta pigment colorant in the ink composition.

14. The ink composition of claim 11 wherein the aqueous liquid vehicle includes from 10 wt % to 50 wt % styrene-acrylic polymer and from 46 wt % to 80 wt % of a co-solvent, based on a total weight of the magenta pigment colorant in the ink composition.

15. The ink composition of claim 14, wherein the co-solvent is a glycol co-solvent and the glycol co-solvent is ethylene glycol, diethylene glycol, triethylene glycol, propylene glycol, dipropylene glycol, 2-methyl-1,3-propanediol, tetraethylene glycol, glycerol, 1-(2-hydroxyethyl)-pyrrolidone, tripropylene glycol methyl ether, or a combination thereof.
